(19) United States
(12) Patent Application Publication
(10) Pub. No.: US 2021/0354273 A1
(43) Pub. Date: Nov. 18, 2021

(54) RATCHET WRENCH CAPABLE OF QUICKLY MOUNTING AND DISMOUNTING A BIT

(71) Applicant: KING TONY TOOLS CO., LTD., TAICHUNG (TW)

(72) Inventor: Ching-Hua Lai, TAICHUNG (TW)

(21) Appl. No.: 16/907,207

(22) Filed: Jun. 20, 2020

(30) Foreign Application Priority Data
May 12, 2020 (TW) 109115719

(51) Int. Cl. B25B 23/00; B25B 13/46

(52) U.S. Cl. CPC B25B 23/0035; B25B 13/463

(57) ABSTRACT

A ratchet wrench capable of quickly mounting and dismounting a bit includes a wrench body and a ratchet wheel rotatably disposed in the wrench body. One side of the ratchet wheel is formed with a slide trough. An end cap is slidably disposed in the slide trough. Another side of the ratchet wheel is formed with a polygonal hole communicating with the slide trough. When a bit is inserted in the polygonal hole, the bit can be quickly positioned by block of the end cap. When the bit is about to be taken out, the bit can be pushed out of the polygonal hole via pressing the end cap, so that the bit can be taken out quickly.

### FIELD OF THE INVENTION

The present invention relates to a ratchet wrench capable of quickly mounting and dismounting a bit.

### BACKGROUND OF THE INVENTION

A conventional ratchet wrench has a main body. One end of the main body is formed with a head. The head has a receiving trough therein. A rotatable ratchet wheel is provided in the receiving trough. One side of the ratchet wheel is provided with an operating unit for controlling and switching the rotational direction of the ratchet wheel. The ratchet wheel is formed with a through hole that is configured for the user to insert and position a bit therein, so as to tighten or loosen a workpiece by the bit.

However, the conventional ratchet wrench adopted the through-hole design. It is difficult for the user to push the bit to a predetermined position when installing the bit and is inconvenient for the user to take out or replace the bit. In view of this, a magnetic member is provided in the through hole in order to locate the bit by magnetic attraction. However, the insufficient magnetic force of the magnetic member results in bad positioning effect, besides, the bit having an outer coating or made of a non-magnetic material is not able to cooperate with the magnetic member. On the other hand, the magnetic member is generally a circular or rectangular magnet, which increases the difficulty in attaching or lodging the magnetic member into the through hole. Furthermore, the reliability is poor in combining the bit and the magnetic member. Once the conventional ratchet wrench is impacted by an external force, the magnetic member is likely to depart from the through hole. Accordingly, the inventor of the present invention has devoted himself based on his many years of practical experiences to solve these problems.

### SUMMARY OF THE INVENTION

The primary object of the present invention is to provide a ratchet wrench capable of quickly mounting and dismounting a bit, which allows a user to quickly, conveniently position the bit to the ratchet wrench and quickly remove the bit from the ratchet wrench.

In order to achieve the aforesaid object, a ratchet wrench capable of quickly mounting and dismounting a bit. The ratchet wrench is in cooperation with a bit when in use. The ratchet wrench comprises a wrench body, an operating unit, a ratchet wheel, and an end cap. One end of the bit is formed with a pushing end, and another end of the bit is formed with a driving end. A circumference of the bit is formed with at least one notch. The wrench body has a handle and a head at one end of the handle. One side of the head is formed with a first accommodating trough. An inner wall of the first accommodating trough is formed with a second accommodating trough. Another side of the head has a first through hole communicating with the first accommodating trough and a second through hole communicating with the second accommodating trough. The operating unit includes at least one pawl accommodated in the second accommodating trough and a knob inserted in the second through hole. The ratchet wheel is rotatably disposed in the first accommodating trough. One side of the ratchet wheel, corresponding to the first through hole, is formed with a slide trough. A bottom of the slide trough is formed with a limiting surface. An inner wall of the slide trough is provided with a limiting portion. A spacing is spaced apart between the limiting portion and the limiting surface. Another side of the ratchet wheel is formed with a polygonal hole communicating with the slide trough. An inner wall of the polygonal hole is provided with a retaining portion. A circumference of the ratchet wheel is formed with a toothed portion corresponding to the pawl. The end cap is slidably disposed in the slide trough. One side of the end cap, corresponding to the polygonal hole, is formed with a pushed portion, and another side of the end cap is formed with a press portion. A circumference of the end cap extends downward to form an annular wall. The annular wall is provided with an abutting portion. The abutting portion is confined between the limiting surface and the limiting portion. A limiting space is defined between an inner side of the annular wall and the pushed portion. The end cap is slidable along an axial direction of the first through hole and movable between a first position and a second position. When the end cap is in the first position, the abutting portion abuts against the limiting surface. When the end cap is in the second position, the abutting portion abuts against the limiting portion.

As to the ratchet wrench capable of quickly mounting and dismounting the bit provided by the present invention, when the bit is inserted in the polygonal hole of the ratchet wheel, the pushing end of the bit is confined in the limiting space of the end cap, and the end cap is pushed to the second position. At this time, the movement stroke of the end cap is limited by the abutting portion to abut against the limiting portion so as to provide a blocking effect, so that the bit cannot be moved any further. Additionally, the retaining portion of the ratchet wheel is engaged with the notch of the bit to position the bit, so the bit can be quickly positioned. When the user intends to remove the bit from the ratchet wrench, by reasons that the end cap is in the second position and the pressing portion of the end cap extends out of the first through hole, the user enables to press the pressing portion to push the bit out of the polygonal hole, and meantime the retaining portion is disengaged from the notch, thereby achieving the effect of quick removing the bit.

### BRIEF DESCRIPTION OF THE DRAWINGS

FIG. 1 is a perspective view in accordance with a preferred embodiment of the present invention;

FIG. 2 is an exploded view in accordance with the preferred embodiment of the present invention;

FIG. 3 is a partially sectional view in accordance with the preferred embodiment of the present invention;

FIG. 4 is a schematic view in accordance with the preferred embodiment of the present invention when in use;

FIG. 5 is a first schematic view showing the operation of the preferred embodiment of the present invention; and

FIG. 6 is a second schematic view showing the operation of the preferred embodiment of the present invention.

### DETAILED DESCRIPTION OF THE PREFERRED EMBODIMENTS

Embodiments of the present invention will now be described, by way of example only, with reference to the accompanying drawings.

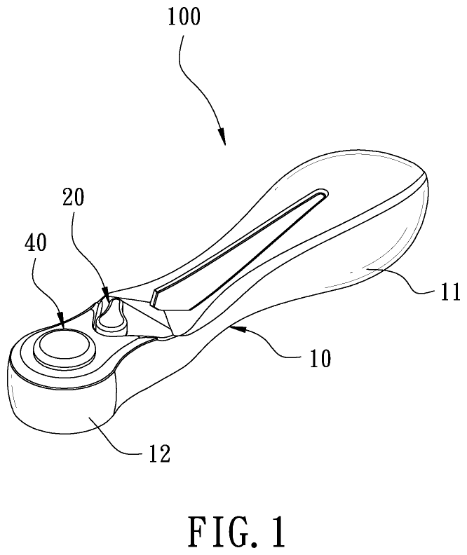

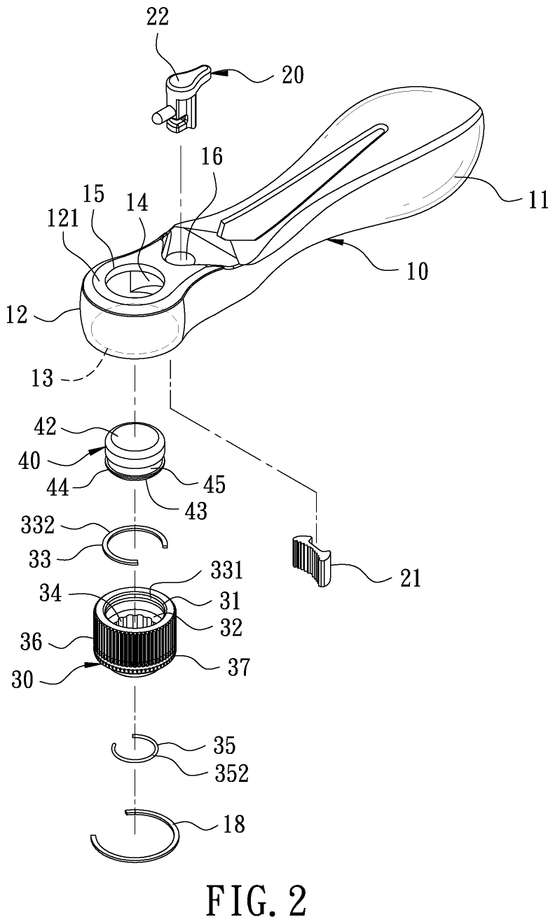

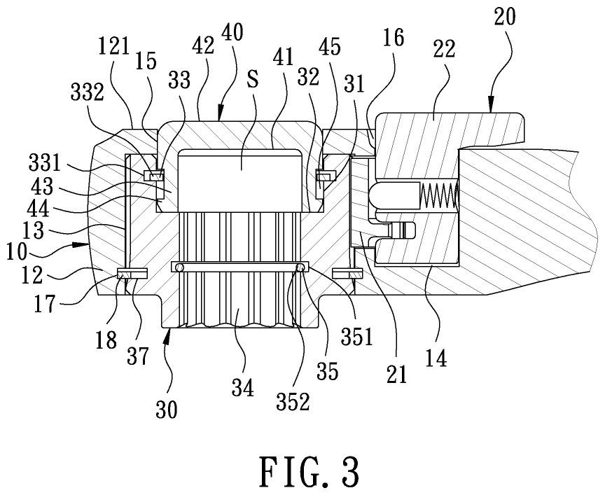

FIG. 1 is a perspective view in accordance with a preferred embodiment of the present invention. FIG. 2 is an exploded view in accordance with the preferred embodiment of the present invention. FIG. 3 is a partially sectional view in accordance with the preferred embodiment of the present invention. The present invention discloses a ratchet wrench 100 capable of quickly mounting and dismounting bits. The ratchet wrench 100 comprises a wrench body 10, an operating unit 20, a ratchet wheel 30, and an end cap 40.

The wrench body 10 has a handle 11 and a head 12 formed at one end of the handle 11. One side of the head 12 is formed with a first accommodating trough 13. An inner wall of the first accommodating trough 13 is formed with a second accommodating trough 14. The other side of the head 12 has a first through hole 15 communicating with the first accommodating trough 13 and a second through hole 16 communicating with the second accommodating trough 14.

The operating unit 20 includes at least one pawl 21 accommodated in the second accommodating trough 14 and a knob 22 inserted in the second through hole 16. The knob 22 is configured to drive the pawl 21 to deflect in the second accommodating trough 14.

The ratchet wheel 30 is rotatably disposed in the first accommodating trough 13. One side of the ratchet wheel 30, corresponding to the first through hole 15, is formed with a slide trough 31. A diameter of the slide trough 31 is approximately equal to a diameter of the first through hole 15. The bottom of the slide trough 31 is formed with a limiting surface 32. An inner wall of the slide trough 31 is provided with a limiting portion 33. A spacing is spaced apart between the limiting portion 33 and the limiting surface 32. In this embodiment, the limiting portion 33 is composed of an annular limiting groove 331 disposed on the inner wall of the slide trough 31 and a limiting ring 332 disposed in the annular limiting groove 331. The other side of the ratchet wheel 30 is formed with a polygonal hole 34 communicating with the slide trough 31. An inner wall of the polygonal hole 34 is provided with a retaining portion 35. In this embodiment, the retaining portion 35 is composed of an annular retaining groove 351 disposed on the inner wall of the polygonal hole 34 and a retaining ring 352 disposed in the annular retaining groove 351. A circumference of the ratchet wheel 30 is formed with a toothed portion 36 corresponding to the pawl 21 to be engaged with the pawl 21 for unidirectional ratcheting action. The inner wall of the first accommodating trough 13 is formed with a first positioning groove 17. The circumference of the ratchet wheel 30 is further formed with a second positioning groove 37 corresponding to the first positioning groove 17 and is provided with a positioning ring 18. The positioning ring 18 is disposed between the first positioning groove 17 and the second positioning groove 37, so that the ratchet wheel 30 is constrained in the first accommodating trough 13.

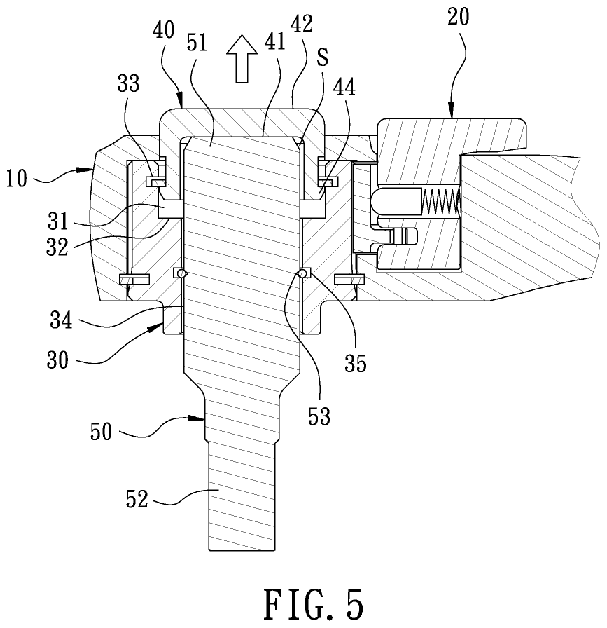

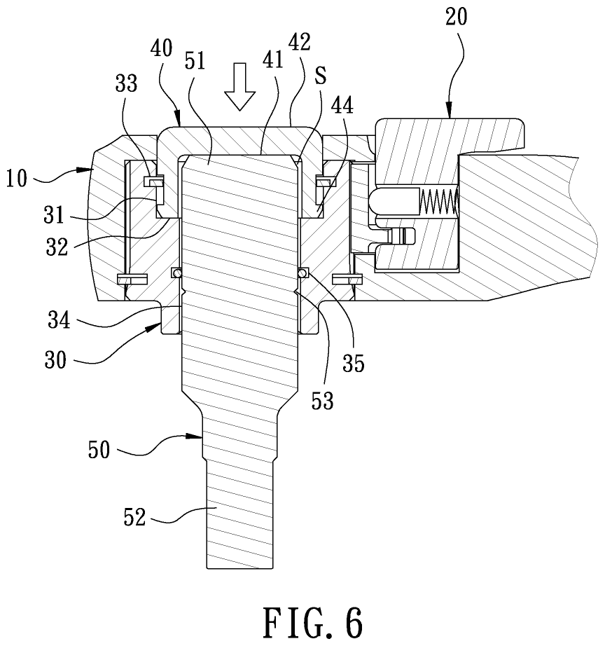

The end cap 40 is slidably disposed in the slide trough 31. One side of the end cap 40, corresponding to the polygonal hole 34, is formed with a pushed portion 41. The other side of the end cap 40 is formed with a press portion 42. A pressing surface of the press portion 42 is not lower than a top surface 121 of the head 12. A circumference of the end cap 40 extends downward to form an annular wall 43. A bottom edge of the annular wall 43 is provided with an abutting portion 44. The abutting portion 44 is confined between the limiting surface 32 and the limiting portion 33. The end cap 40 is slidable along the axial direction of the first through hole 15 and movable between a first position and a second position. When the end cap 40 is in the first position, as shown in FIG. 5, the abutting portion 44 abuts against the limiting surface 32. When the end cap 40 is in the second position, as shown in FIG. 6, the abutting portion 44 abuts against the limiting portion 33 to make the press portion 42 extend out of the first through hole 15. At this time, a surface of the pushed portion 41 of the end cap 40 is approximately flush with the top surface 121 of the head 12. Because an outer diameter of the annular wall 43 of the end cap 40 is slightly less than the diameter of the first through hole 15 and the slide trough 31, the end cap 40 enables to smoothly slide axially between the first position and the second position. In this embodiment, an outer surface of the annular wall 43 of the end cap 40 is formed with a receiving groove 45. The limiting ring 332 is accommodated in the receiving groove 45 and the annular limiting groove 331.

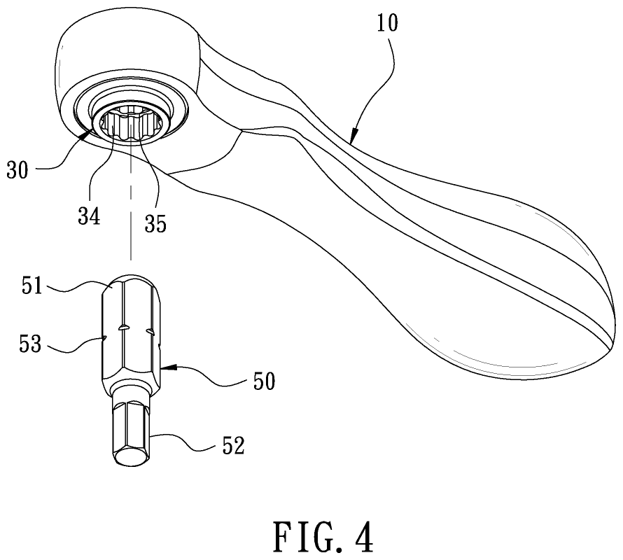

FIG. 4 is a schematic view in accordance with the preferred embodiment of the present invention when in use. FIG. 5 is a first schematic view showing the operation of the preferred embodiment of the present invention. When in use, the ratchet wrench 100 is in cooperation with at least one bit 50. One end of the bit 50 is formed with a pushing end 51, and the other end of the bit 50 is formed with a driving end 52. A circumference of the bit 50 is formed with a plurality of notches 53. It should be noted that a distance between the pushing end 51 and one of the notches 53 is approximately equal to a distance between the pushed portion 41 and the retaining portion 35 when the end cap 40 is in the second position. As shown in FIG. 5, when the pushing end 51 of the bit 50 is inserted into the polygonal hole 34, the pushing end 51 abuts against the pushed portion 41 of the end cap 40 and is confined in a limiting space S formed by the annular wall 43 and the pushed portion 41 of the end cap 40, thereafter the end cap 40 is pushed by the bit 50 to move outward relative to the first through hole 15 until the abutting portion 44 abuts against the limiting portion 33. Meantime, the retaining portion 35 is engaged in the notches 53, so that the bit 50 is positioned to the ratchet wrench 100, thereby achieving the effect of quick positioning the bit 50. Owing to the reason that the limiting space S formed by the pushed portion 41 and the annular wall 43 of the end cap 40 can effectively cover and position the bit 50, when the bit 50 is inserted in the polygonal hole 34, the end cap 40 can effectively prevent the bit 50 from extending out of the head 12 if the user applies an excessive force to the bit 50.

FIG. 6 is a second schematic view showing the operation of the preferred embodiment of the present invention. When the user intends to remove the bit 50 from the ratchet wrench 100, by reasons that the end cap 40 is in the second position and the pressing portion 42 of the end cap 40 extends out of the first through hole 15 the user enables to press the pressing portion 42 to push the bit 50 out of the polygonal hole 34, and meantime the retaining portion 35 is disengaged from the notches 53, thereby achieving the effect of quick removing the bit 50.

It is worth mentioning that, in this embodiment, the end cap 40 is slidably disposed in the slide trough 31 of the ratchet wheel 30, and the limiting space S is defined between the annular wall 43 and the pushed portion 41. Mentioned design enables to reduce the thickness of the head 12 and make the ratchet wrench 100 suitable for use in a confined space and allowing the end cap 40 to extend outward slightly from the first through hole 15. When the ratchet wrench 100 is impacted by an external force to fall on the ground, the possibility for directly impacting the end cap 40 can be substantially decreased, thereby preventing damages to the end cap 40. It is worth mentioning that, since the ratchet wrench 100 provides the retaining portion 35 to engage with the notches 53 of the bit 50 for positioning, the design in this invention enables the bit 50 to be applicable to various kinds of materials or coatings compared to prior art.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A ratchet wrench, in cooperation with a bit when in use, comprising:
a wrench body, having a handle and a head formed at one end of the handle, one side of the head being formed with a first accommodating trough, an inner wall of the first accommodating trough being formed with a second accommodating trough, another side of the head having a first through hole communicating with the first accommodating trough and a second through hole communicating with the second accommodating trough;
an operating unit, including at least one pawl accommodated in the second accommodating trough and a knob inserted in the second through hole;
a ratchet wheel, rotatably disposed in the first accommodating trough, one side of the ratchet wheel, corresponding to the first through hole, being formed with a slide trough, a bottom of the slide trough being formed with a limiting surface, an inner wall of the slide trough being provided with a limiting portion, a spacing being spaced apart between the limiting portion and the limiting surface, another side of the ratchet wheel being formed with a polygonal hole communicating with the slide trough, an inner wall of the polygonal hole being provided with a retaining portion, a circumference of the ratchet wheel being formed with a toothed portion corresponding to the pawl;
an end cap, slidably disposed in the slide trough, one side of the end cap, corresponding to the polygonal hole, being formed with a pushed portion, another side of the end cap being formed with a press portion, a circumference of the end cap extending to form an annular wall, the annular wall being provided with an abutting portion, the abutting portion being confined between the limiting surface and the limiting portion, a limiting space being defined between an inner side of the annular wall and the pushed portion, wherein the end cap is slidable along an axial direction of the first through hole and movable between a first position and a second position, when the end cap is in the first position, the abutting portion abuts against the limiting surface, when the end cap is in the second position, the abutting portion abuts against the limiting portion.

2. The ratchet wrench as claimed in claim 1, wherein one end of the bit is formed with a pushing end, another end of the bit is formed with a driving end, a circumference of the bit is formed with at least one notch, when the bit is inserted in the polygonal hole of the ratchet wheel to push the end cap to the second position, the retaining portion is engaged in the notch, and the pushing end of the bit abuts against the pushed portion of the end cap and is confined in the limiting space.

3. The ratchet wrench as claimed in claim 2, wherein a distance between the pushing end of the bit and the notch is approximately equal to a distance between the pushed portion of the end cap and the retaining portion when the end cap is in the second position.

4. The ratchet wrench as claimed in claim 1, wherein an outer surface of the annular wall of the end cap is formed with a receiving groove, the limiting portion includes an annular limiting groove disposed on the inner wall of the slide trough and a limiting ring, and the limiting ring is accommodated in the receiving groove and the annular limiting groove.

5. The ratchet wrench as claimed in claim 1, wherein when the end cap is in the second position, the press portion of the end cap extends out of the first through hole of the wrench body, and a surface of the pushed portion of the end cap is approximately flush with a top surface of the head.

6. The ratchet wrench as claimed in claim 1, wherein the retaining portion includes an annular retaining groove disposed on the inner wall of the polygonal hole and a retaining ring disposed in the annular retaining groove.

7. The ratchet wrench as claimed in claim 1, wherein the inner wall of the first accommodating trough is formed with a first positioning groove, the circumference of the ratchet wheel is formed with a second positioning groove corresponding to the first positioning groove and provided with a positioning ring, and the positioning ring is disposed between the first positioning groove and the second positioning groove to restrain the ratchet wheel in the first accommodating trough.

8. The ratchet wrench as claimed in claim 1, wherein the first through hole has a diameter approximately equal to that of the slide trough, and the annular wall of the end cap has an outer diameter slightly less than the diameter of the first through hole.

9. The ratchet wrench as claimed in claim 1, wherein the abutting portion is formed at a bottom edge of the annular wall.
